(19) United States
(12) Patent Application Publication
(10) Pub. No.: US 2011/0154796 A1
(43) Pub. Date: Jun. 30, 2011

(54) ELECTRIC HEDGE TRIMMER

(75) Inventor: Miyoji ONOSE, Hitachinaka-shi (JP)

(73) Assignee: HITACHI KOKI CO., LTD.

(21) Appl. No.: 12/979,898

(22) Filed: Dec. 28, 2010

(30) Foreign Application Priority Data
Dec. 28, 2009 (JP) 2009-298786

(51) Int. Cl. A01G 3/04; H02K 7/14

(52) U.S. Cl. 56/233; 310/50

(57) ABSTRACT

An electric hedge trimmer comprises a flat motor that is provided inside a housing and includes a rotor having a disk shaped coil disk on which a plurality of substantially ring-shaped coils are formed and arranged in the circumferential direction a motor output shaft as seen in the direction of the axis line of the motor output shaft, a magnet that generates a magnetic flux that passes through the coil disk in the direction of the axis line of the motor output shaft, a gear section that reduces the speed of rotation of the motor output shaft and has a gear section output shaft that outputs the reduced rotation, a cam that is connected to the gear section output shaft, converts the rotating motion of the gear section output shaft to reciprocating motion, and a blade section that is connected to the cam and has reciprocating motion.

### CROSS-REFERENCE TO RELATED APPLICATION

This application claims the benefit of Japanese Patent Application No. 2009-298786, filed Dec. 28, 2009, the entire disclosure of which is incorporated by reference herein.

### FIELD

This application relates generally to electric hedge trimmer, and more particularly, to electric hedge trimmer that comprise a flat motor.

### BACKGROUND

For example, as disclosed in Unexamined Japanese Patent Application KOKAI Publication No. 2006-115709, electric hedge trimmer comprise a motor that is housed inside a housing, a reduction gear that is connected to the output shaft of the motor, a cam that is connected to the gear and converts the rotating motion of the motor to reciprocating motion, and reciprocating blades that are connected to the cam and protrude from the housing. Typically, a DC motor having a long dimension in the axial direction of the output shaft is used as the motor.

Incidentally, in the electric hedge trimmer described above, the motor is long in the direction of the output shaft, so that it is very difficult to reduce the dimensions of the housing in the direction of the output shaft of the motor. Therefore, when performing trimming work of branches, grass and the like in a narrow space, there is a problem in that there is contact with the housing of the electric hedge trimmer and the trimming work becomes difficult.

### SUMMARY

Taking the problem above into consideration, it is the object of the present invention to provide an electric hedge trimmer that are compact and improve operability by shortening the dimension in the axial direction of the output shaft of the motor.

In order to accomplish the object above, the electric hedge trimmer of the present invention comprises:

a housing;

a flat motor having a magnetic flux generating unit that is provided inside the housing, a rotor that includes a motor output shaft and that is rotatably provided inside the housing, and a stator that is fastened inside the housing; wherein one of either the rotor or the stator has a disk shaped coil disk around which a plurality of ring-shaped coils are arranged in the circumferential direction with the motor output shaft as the center as seen in the direction of the motor output shaft; and the other one of either the rotor or the stator generates a magnetic flux that passes through the coil disk in the axial direction of the motor output shaft;

a motion conversion device that is capable of connecting to blades that protrude from the housing and move in a reciprocating motion, the motion conversion device converting the rotating motion of the motor output shaft to reciprocating motion.

Moreover, it is possible for

the rotor and stator to be housed in a motor housing;

the motor output shaft to protrude from the motor housing; and

the motor housing to be housed in the housing.

Furthermore, preferably the housing is separable, having a plane of separation that is substantially parallel with the protruding direction of the blades from the housing;

the motor housing is separable, having a plane of separation that is substantially perpendicular to the axial direction of the motor output shaft; and

the separation plane of the housing and the separation plane of the motor housing are substantially orthogonal.

In addition, it is preferred that the electric hedge trimmer further comprise

a reducer that is provided between the flat motor and motion conversion device on the inside of the housing; the reducer being connected to the motor output shaft and having a reducer output shaft that outputs the reduced speed of the motor output shaft; wherein

the motion conversion device is connected to the reducer output shaft and converts the rotating motion of the reducer output shaft to reciprocating motion.

Furthermore, preferably

the rotor includes the coil disk;

the motor housing supports the motor output shaft such that the motor output shaft can rotate; and

the magnetic flux generating unit comprises a magnet and is attached to the motor housing so that the magnet faces the disk surface of the coil disk.

The Housing can Also Comprise:

a flat section that is formed substantially parallel with the disk surface of the coil disk on the opposite side from the blades with the flat motor in between in the axial direction of the motor output shaft;

a bottom section that covers a connecting section which connects the blades and the motion conversion device on the side of the motion conversion device in the direction of the motor output shaft that faces the blades; and

a first handle that is located between the flat section and bottom section of the housing in the axial direction of the motor output shaft, and extends in the direction opposite from protruding direction of the blades with the flat motor in between the handle and the blades.

The housing can also further comprise:

a protruding section that protrudes from the flat section toward the outside of the housing in the axial direction of the motor output shaft and has a substantially circular outer wall as seen in the axial direction of the motor output shaft; and

a second handle that is installed on the outer wall and comprising an extending section that extends from the protruding section along the flat section, and a grip section that the user holds and that is connected to the extending section; the second handle being able to rotate around the protruding section as seen in the axial direction of the motor output shaft.

A battery that supplies electric power to the flat motor can also be installed at the end section of the first handle that is away from the blade as seen in the axial direction of the motor output shaft such that the battery is removable.

The battery that supplies electric power to the flat motor can also be installed on the housing between the motor output shaft and the first handle as seen in the axial direction of the motor output shaft such that the battery overlaps part of the motor housing and is removable from the flat surface side of the housing.

Moreover, a second handle can be installed on the housing such that the second handle extends in the opposite direction from the first handle with the motor output shaft in between the first handle and second handle as seen in the direction of the motor output shaft.

Furthermore, the housing can comprise:

a flat section that is formed substantially parallel with the disk surface of the coil disk on the opposite side of the blades in the axial direction of the motor output shaft with the flat motor in between; and

a first handle having a handle protruding section that protrudes from the housing in the direction of the motor output shaft opposite the direction facing the blades, a handle grip section that is apart from the flat section and extends substantially parallel to the protruding direction of the blades from the end section of the handle protruding section that is away from the housing such that the handle grip section overlaps the motor output shaft as seen in the direction of the motor output shaft.

A sliding switch may be provided in the handle grip section such that the switch can slide along the extending direction of the handle grip section and control the rotation of the flat motor.

A second handle can also be provided on the first handle such that the second handle protrudes from the end section of the blade side of the first handle toward substantially the same direction as the protruding direction of the blades as seen in the direction of the motor output shaft, the second handle having a grip section that extends substantially perpendicular to the extending direction of the first handle.

Furthermore, the battery that supplies electric power to the flat motor can be installed in the end section of the first handle that is away from the blades as seen in the axial direction of the motor output shaft such that the battery is removable.

The electric hedge trimmer may comprise:

a housing;

a flat motor having a disk shaped coil disk;

a motion conversion device is capable of connecting to blades that protrude from the housing and move in a reciprocating motion, the motion conversion device converting the rotating motion of the flat motor to reciprocating motion

With the present invention, by using a flat motor it is possible to suppress the dimension in the axial direction of the motor output shaft, and thus the electric hedge trimmer can be made more compact and operability can be improved.

### BRIEF DESCRIPTION OF THE DRAWINGS

A more complete understanding of this application can be obtained when the following detailed description is considered in conjunction with the following drawings, in which:

FIG. 1 is a side view of electric hedge trimmer of a first embodiment of the present invention;

FIG. 2 is a top view of the electric hedge trimmer in FIG. 1;

FIG. 3 is bottom view of the electric hedge trimmer in FIG. 1;

FIG. 4 is a cross-sectional view of section IV-IV in FIG. 2;

FIG. 5 is an enlarged view of the main parts in FIG. 3;

FIG. 6 is an exploded cross-sectional view of the rotor of the electric hedge trimmer in FIG. 1;

FIG. 7 is a top view of the coil/commutator disk of the rotor in FIG. 6;

FIG. 8 is a top view of the coil disk section of the rotor in FIG. 6;

FIG. 9 is a side view of electric hedge trimmer of a second embodiment of the present invention;

FIG. 10 is a top view of the electric hedge trimmer in FIG. 9;

FIG. 11 is a side view of electric hedge trimmer of a third embodiment of the present invention;

FIG. 12 is a top view of the electric hedge trimmer in FIG. 11;

FIG. 13 is a cross-sectional view of section in FIG. 12;

FIG. 14 is a side view of a variation of the rotor of the electric hedge trimmer of the present invention;

FIG. 15 is an exploded cross-sectional view of the rotor in FIG. 14;

FIG. 16 is a bottom view of the yoke section of the rotor in FIG. 14; and

FIG. 17 is a bottom view of the fan section of the rotor in FIG. 14.

### DETAILED DESCRIPTION

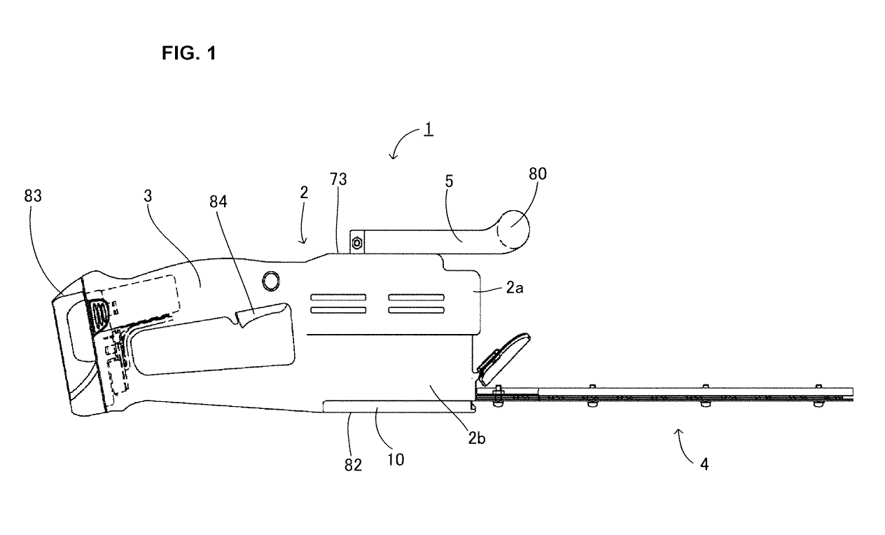

In the following, a first embodiment of the present invention is explained with reference to the accompanying drawings FIG. 1 to FIG. 8. As illustrated in FIG. 1 to FIG. 3, the electric hedge trimmer 1 comprise: a housing 2, a main handle (first handle) 3 that extends from the housing 2 toward the rear (left side in the figures), a blade section 4 that protrudes from the bottom section at the bottom portion of the housing 2 (bottom in the figures) toward the front (right side in the figures), and a sub handle (second handle) 5 that is attached to the top portion of the housing. The housing 2 comprises housing half sections 22a, 22b that can be separated in two along the longitudinal direction of the blade section 4.

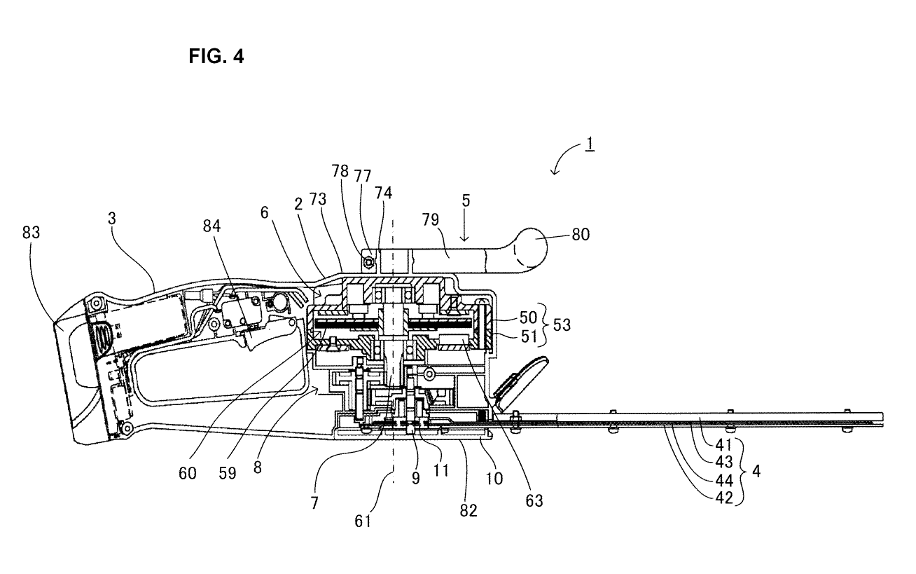

As illustrated in FIG. 4, a flat motor 6 is housed in the upper portion inside the housing 2. The flat motor 6 has a motor output shaft 7 that protrudes downward. A gear unit (reduction gear) 8 is provided underneath the flat motor 6. The gear unit 8 reduces the speed of rotation of the motor output shaft 7 and transmits that rotation to the gear unit output shaft (reduction gear output shaft) 9 that protrudes downward from the gear unit 8. A cam (motion converting device) 11 that is attached to the gear unit output shaft 9 is provided between the gear unit 8 and the bottom cover 10 at the bottom portion of the gear unit 8. The blade unit 4 comprises a holder plate 41, a blade holder 42, and overlapping top blade (cutting blade) 43 and lower blade (cutting blade) 44 that are provided between the holder plate 41 and blade holder 42 such that they are capable of reciprocating motion. The top blade 43 and lower blade 44 are both connected to the cam 11 so that they move back and forth with a phase difference between them of 180 degrees, for example. In addition, the blade holder 42 is fastened to the housing 2 (inside the space enclosed by the bottom cover 10 and housing 2) above the bottom cover (bottom section) 10.

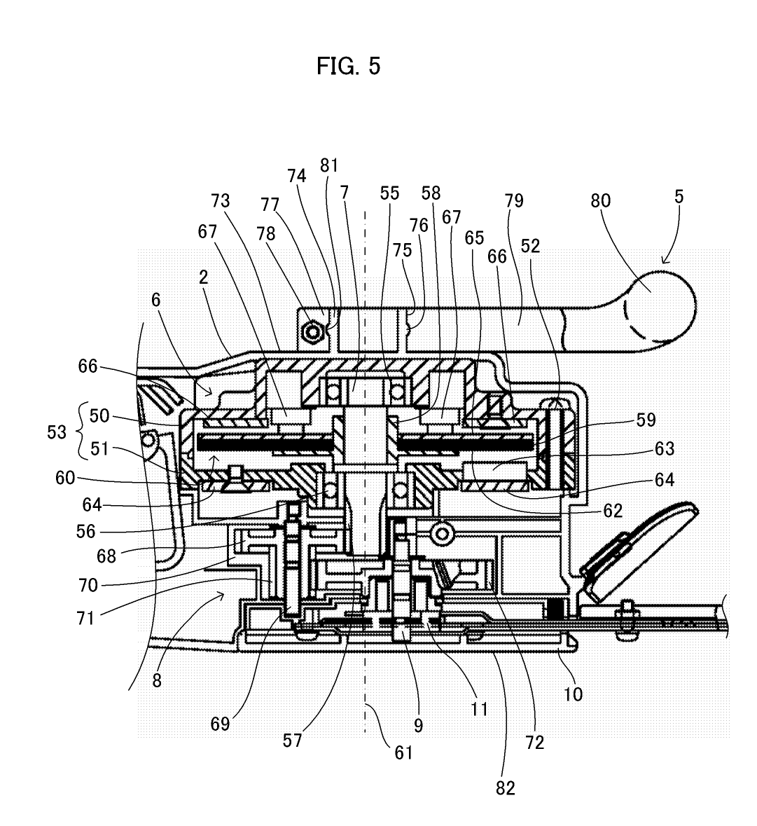

As illustrated in FIG. 5, the flat motor 6 that is housed in the housing 2 has flat cylindrical shaped motor housing 53 that is assembled by fastening together a first motor housing unit 50 and a second motor housing unit 51 with screws 52. The motor output shaft 7 that protrudes from the second motor housing unit 51 is supported by a first bearing 55 that is attached to the first motor housing unit 50 and a second bearing 56 that is attached to the second motor housing unit 51 so that it can rotate. The end section of the motor output shaft 7 that protrudes from the second motor housing unit 51 is processed by a gear cutting process to form a flat gear shaped pinion gear 57. A disk shaped coil disk 59, which is formed by layering a plurality of disks, the surface of which have been formed with a plurality of coil patterns, is fastened to the motor output shaft 7 between the first bearing 55 and second bearing 56 by way of a flange 58. The motor output shaft 7, flange 58 and coil disk 59 together form the rotor 60 of the flat motor 6.

Magnets 63, such as a plurality of permanent magnets or electromagnets that are arranged at intervals in the circumferential direction facing the lower disk surface 62 in FIG. 5 of the coil disk 59, and a ring shaped iron yoke 64 are attached to the second motor housing unit 51 inside the motor housing 53 so that magnetic flux passes through the coil of the coil disk 59 in the direction of the axis 61 of the motor output shaft 7. Moreover, a ring shaped iron yoke 66 is attached to the first motor housing unit 50 at a position facing the upper disk surface 65 in FIG. 5 of the coil disk 59 that is between it and the coil disk 59, and at a position corresponding to the iron yoke 64 as seen in the direction of the axis 61 of the motor output shaft 7. The permanent magnets 63, iron yokes 64 and 66 form a magnetic flux generating unit. However, as long as the magnetic flux passes through the coil of the coil disk 59 in the direct of the axis line 61 of the output shaft 7, the magnetic flux generating unit is not limited to this construction; for example, the magnetic flux generating unit can be formed from just a plurality of permanent magnets, electromagnets or a coil. Furthermore, brushes 67 for supplying electric current to the coil of the coil disk 59 are attached to the first motor housing unit 50 such that they come in contact with the upper disk surface 65 of the coil disk 59. The motor housing 53, in which these permanent magnets 63, and iron yokes 64, 66 are provided, forms the stator of the flat motor 6. Moreover, the flat motor 6 is constructed as a flat direct-current commutator motor from the motor output shaft 7 and the coil disk 59 that is fastened to the motor output shaft 7, which function as a rotor 60, and the permanent magnets 63, iron yokes 64, 66 and the brushes 67, which function as a stator.

As illustrated in FIG. 5, a first gear 68 having a larger diameter than the pinion gear 57 engages with the pinion gear 57 on the motor output shaft 7 of the flat motor 6. The first gear 68 is fastened to an intermediate shaft 69, and a gear housing 70 supports that intermediate shaft 69 such that it can rotate. A second gear 71 having a smaller diameter than the first gear 68 is fastened underneath the first gear 68 on the intermediate shaft 69. The second gear 71 engages with a third gear 72 that has a larger diameter than the second gear 71 and that is fastened to the gear unit output shaft 9. The gear housing 70 supports the gear unit output shaft 9 so that it can rotate. In addition, a cam 11 is fastened underneath the third gear 72 on the gear unit output shaft 9. The cam 11 converts the rotating motion of the gear unit output shaft 9 to reciprocating motion, and transmits that motion to the upper blade 43 and lower blade 44. The first gear 68 and second gear 71 that are fastened to the intermediate shaft 69, and the third gear 72 that is fastened to the gear unit output shaft 9 form the gear unit 8 that reduces the speed of the rotation of the motor output shaft 7 and outputs that rotation from the gear unit output shaft 9.

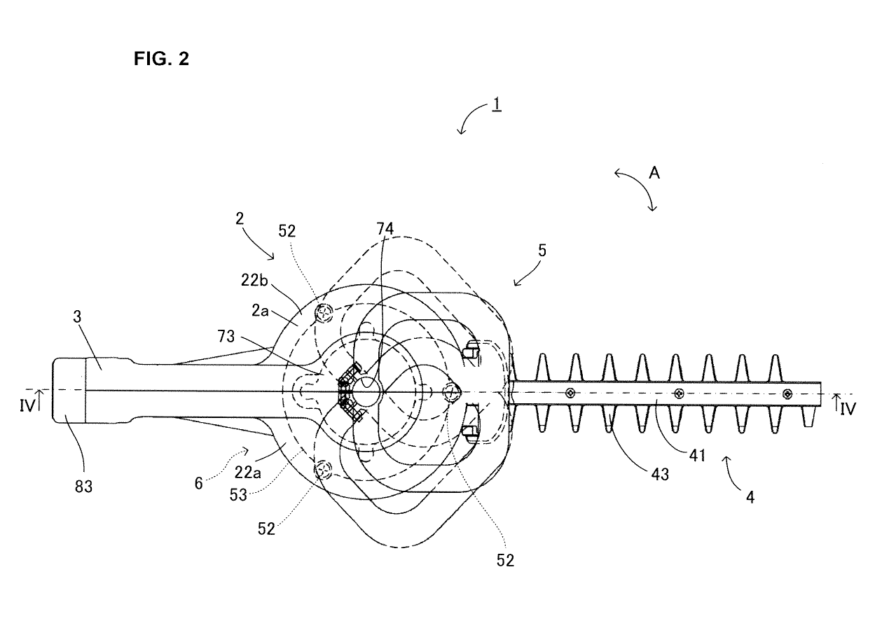

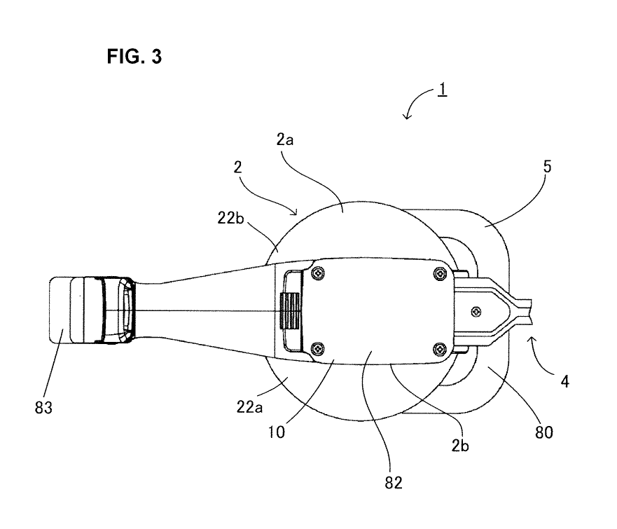

As illustrated in FIG. 4 and FIG. 5, a flat section 73, which is substantially parallel with the disk surfaces 62, 65 of the coil disk 59, is formed on the wall surface located on the flat motor 6 side (top in the figures) of the housing 2. A cylindrical shaped protruding section 74 is formed on the flat section 73 such that it protrudes outward from the housing 2 in the direction of the axis 61 of the motor output shaft 7. In addition, a ring shaped protrusion 76 is formed around the outer wall 75 of the protruding section 74 such that it protrudes toward the outside from the outer wall 75 as seen in the direction of the axis 61 of the motor output shaft 7. Moreover, as illustrated in FIG. 2 and FIG. 3, in the upper portion (flat motor side) of the housing 2 there is a circular column shaped motor housing unit 2a that protrudes in the width direction (vertically in the figures) for housing the flat motor 6. Moreover, underneath the motor housing unit 2a of the housing 2 there is a rectangular shaped gear housing unit 2b that has a smaller dimension in the width direction than the motor housing unit 2a.

As illustrated in FIG. 2, a substantially D-shaped sub handle 5 as seen from above (as seen in the direction of axis 61 of the motor output shaft 7 illustrated in FIG. 4 and FIG. 5) is attached to the protruding section 74 such that it can rotate above the flat section 73 in the direction of the arrow A. As illustrated in FIG. 4 and FIG. 5, the sub handle 5 comprises a surrounding section 77 that surrounds the outer wall 75 and ring-shaped protrusion 76 of the protruding section 74, an attachment screw section 78 for fastening the surrounding section 77 against the outer wall 75 and ring-shaped protrusion 76 so that it does not rotate in the direction of the arrow A, an extending section 79 that extends along the flat section 73 substantially parallel with the disk surfaces 62, 65 of the coil disk 59, and a grip section 80 that is connected to the extending section 79 at a position that is separated a little more from the flat section 73 in the direction of the axis 61 of the motor output shaft 7 than the extending section 79. A ring-shaped concave section 81 is formed on the surrounding section 77 such that it corresponds to the ring-shaped protrusion 76. The ring-shaped concave section 81 guides the sub handle 5 such that it rotates around the outer wall 75 of the protruding section 74, and together with the attachment screw section 78, prevents the sub handle 5 from separating from the outer wall 75.

As illustrated in FIG. 1 and FIG. 4, a substantially D-shaped main handle 3 that is integrated with the housing 2 is formed on the housing 2. The main handle 3 extends toward the rear (left in the figures) from the motor housing unit 2a and gear housing unit 2b between a flat surface 82 of the bottom cover 10, which is substantially parallel with the disk surfaces 62, 65 of the coil disk 59, and the flat section 73 in the direction of the axis 61 of the motor output shaft 7. A battery 83 for supplying electric power to the flat motor 6 is installed in the rear end (left end in the figure) of the main handle 3 so that it is removable. In addition, a switch 84 is provided on the main handle 3 that controls the distribution of power to the flat motor 6.

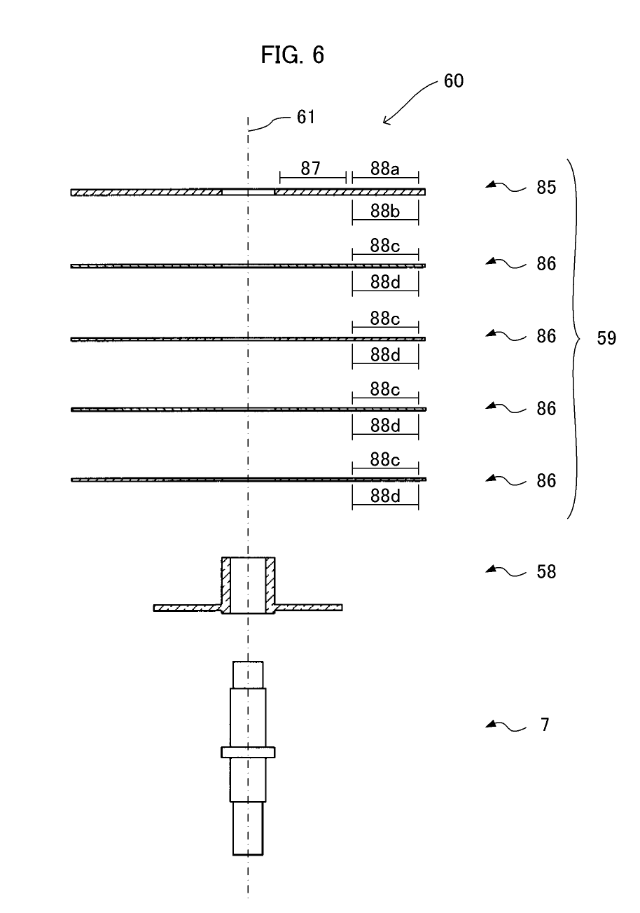

As illustrated in FIG. 6, the rotor 60 of the flat motor 6 comprises the motor output shaft 7, flange 58 and coil disk 59 in which a coil/commutator disk 85 and four coil disks 86 are layered in that order from top to bottom in FIG. 6. The coil commutator 85 and coil disk unit 86 are printed circuit boards comprising an insulator substrate and a conductor pattern. A commutator area 87 in which the conductor pattern of the commutator is formed, and a coil area 88a in which the conductor pattern of the coil is formed, are provided on the top surface of the coil/commutator disk 85. The commutator area 87 and coil area 88a are formed in a circular ring shape around the axis line 61 as the center, and are such that the coil area 88a is located on the outer side of the commutator area 87 as seen in the direction of the axis line 61 of the motor output shaft 7. Moreover, a coil area 88b for forming a conduction pattern for a coil is provided on the bottom surface of the coil/commutator disk 85. The coil area 88b is formed in a circular ring shape around the axis line 61 as the center, and is arranged such that it coincides with the coil area 88a as seen in the direction of the axis line 61.

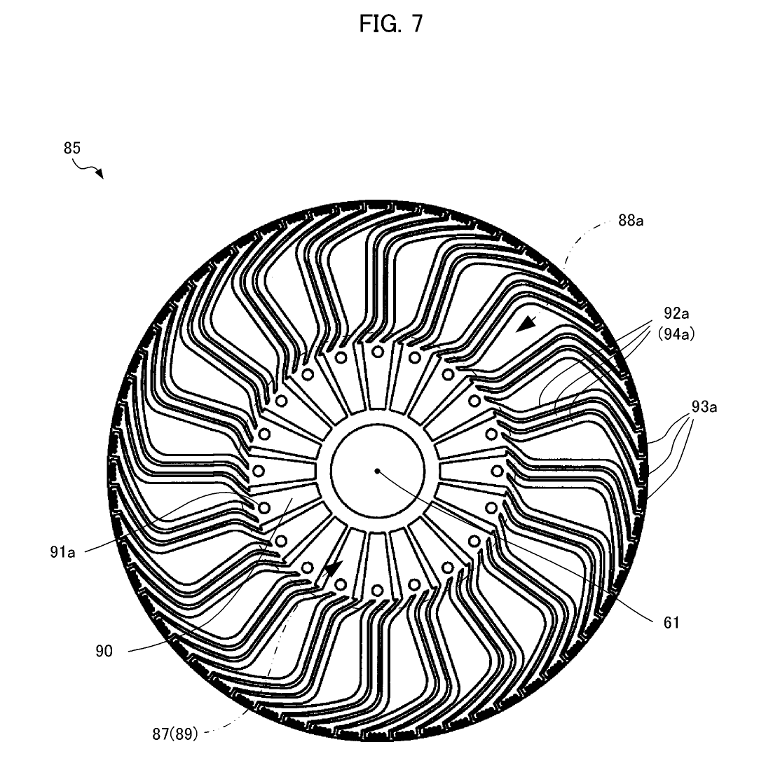

As illustrated in FIG. 7, a commutator 89 that comes in contact with the brushes 67 is formed in the commutator area 87 on the top surface of the coil/commutator disk 85 using a conductor pattern. The commutator 89 comprises a plurality of commutator sections 90 that are formed in a radial shape with the center being the axis line 61. A through hole 91a that passes through the coil/commutator disk 85 is formed at the outside end section of each commutator section 90.

A plurality of coil sections 92a are formed in a radial shape with the center being the axis line 61 in the coil area 88a on the top surface of the coil/commutator disk 85 using a conductor pattern. The inside end section of each coil section 92a is formed such that it connects directly to the corresponding commutator section 90. In addition, the outside end section of each coil section 92a is formed such that it bends in a specified direction around the axis line 61. A plurality of through holes 93a that pass through the coil/commutator disk 85 are formed on the outside end section of each coil section 92a.

A plurality of coil sections are formed in a radial shape with the center being the axis line 61 in the coil area 88b on the bottom surface of the coil/commutator disk 85 using the same conductor pattern as in the coil area 88a illustrated in FIG. 7. The outside end section of each coil section (not shown) is connected to the corresponding coil section 92a in coil area 88a by solder that is filled into the through holes 93a. Moreover, the inside end section of each coil section (not shown) is connected to the corresponding commutator section 90 in the commutator area 87 by solder that is filled into the through hole 91a. By doing so, the plurality of coils 92a in coil area 88a and the plurality of coils in coil area 88b (not shown) form a plurality of coils 94a that are formed in a substantially U-shape as seen in the direction of the axis line 61. The plurality of coils 94a is arranged in the circumferential direction with the axis line 61 as the center. The terminal end of each coil 94a is connected to the corresponding section 90 in the commutator area 87.

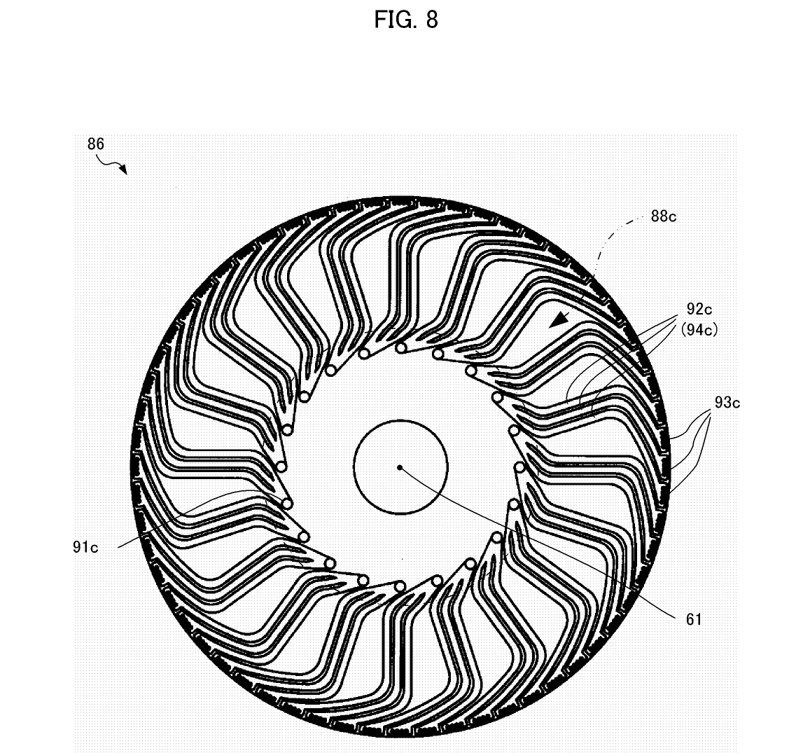

As illustrated in FIG. 6 and FIG. 8, coil areas 88c, 88d that are formed using a coil conductor pattern are provided on the top surface and bottom surface of the coil disk unit 86, respectively. The coil areas 88c, 88d are in a circular ring shape with the axis line 61 as the center of each, and as seen in the direction of axis line 61, the coil areas 88a, 88b of the coil/commutator disk 85 are aligned with each other.

Conductor patterns that are substantially the same as those in coil areas 88a, 88b of the coil/commutator disk 85 are formed in coil areas 88c, 88d of the coil disk unit 86. As illustrated in FIG. 8, a plurality of coil sections 92c are formed in a radial shape with the center axis 61 as the center in the coil area 88c on the top surface of the coil disk 86. Moreover, a plurality of coil sections are formed in the coil area 88d on the bottom surface of the coil disk 86 using the same conductor pattern as in the coil area 88c. The plurality of coil sections 92c in coil area 88c and the plurality of coil sections in coil area 88d (not shown) are connected to each other by solder that is filled in the respective through holes 91c, 93c that pass through the coil disk unit 86, to form a plurality of substantially U-shaped coils 94c as seen in the direction of the axis line 61. The plurality of coils 94c is arranged in the circumferential direction with the axis line 61 as the center. In addition, the terminal end of each coil 94c is connected to a corresponding commutator section 90 in the commutator area 87 by solder that is filled into the through holes 91a in the coil/commutator disk 85.

The conduction patterns in the commutator area 87 and the coil area 88a on the coil/commutator disk 85 are formed on the same printed circuit board. Moreover, in order to prevent damage due to wear by the brushes 67, the conductor patterns in the commutator area 87 and the coil area 88a on the coil/commutator disk 85 are formed thicker than the coil area 88b and the coil areas 88c, 88d on the coil disk unit 86.

Coils 94a, 94c are layered between the coil disk unit 86 and the coil/commutator disk 85 above and between the plurality of coil disk units 86 via insulating layers so that they overlap in the direction of axis line 61, or coils 94a, 94c are arranged at specified angles around the axis line 61.

When performing trimming work with the electric hedge trimmer 1 constructed in this way, the user holds the main handle 3 provided with the switch 84 with one hand, and holds the grip section 80 of the sub handle 5 with the other hand. When the user turns ON the switch 84, a specified voltage is applied to the brushes 67. The voltage that is applied to the brushes 67 is then applied to the coils 94a, 94c formed on the coil disk 59 via the commutator 89. Electric current flows in the coils 94a, 94c to which voltage is applied in the substantially radial direction of the coil disk 59 and perpendicular to the direction of the axis line 61 of the motor output shaft 7. The commutator 89 controls the direction that the current flows. On the other hand, a magnetic flux that occurs in the magnet 63 passes through the coil disk 59 in the direction of the axis line of the output shaft 7 in a direction perpendicular to the electric current. Therefore, torque occurs in the coil disk 59 in the circumferential direction of the coil disk 59 with the center being the axis line 61, and that torque rotates the coil disk 59 and motor output shaft 7. The rotation of the motor output shaft 7 is transmitted from the pinion gear 57 through the first gear 68, intermediate shaft 69, second gear 71, and third gear 72 in the gear housing 70, where it is reduced, and output from the gear unit output shaft 9. The rotating motion of the gear unit output shaft 9 is converted by the cam 11 that is fastened to the gear unit output shaft 9 and output as the reciprocating motion of the upper blade 43 and lower blade 44, such that branches and the like that enter between the upper blade 43 and lower blade 44 are cut.

The electric hedge trimmer 1 use this flat motor 6 wherein coils are formed in the disks of the coil disk 59. Therefore, when compared with a motor having coil that is wound around a core, the rotor 60 is lightweight and the rotor 60 can be activated quickly. Moreover, it becomes possible to greatly suppress the dimension in the direction of the axis line 61 of the motor output shaft 7, and thus make the electric hedge trimmer 1 more compact. Furthermore, contact between the housing 2 of the electric hedge trimmer 1 and branches and the like can be suppressed even in narrow places, thus greatly improving operability in narrow places. The main handle 3 extends toward the rear of the housing between the flat section 73 of the housing 2 and the flat surface 82 of the bottom cover 10 in the direction of the axis line 61 of the motor output axis 7, and a battery 83 is installed in the rear end of the main handle 3 such that it is removable. Therefore, from this aspect, in addition to being possible to suppress the dimension in the direction of the axis line 61 of the motor output shaft 7, it is possible to improve operability in narrow places.

Furthermore, the sub handle 5 extends along the flat section 73 of the housing 2. Therefore, even when a sub handle 5 is provided, it becomes possible to suppress the dimension of the electric hedge trimmer 1 in the direction of the axis line 61 of the motor output shaft 7. The sub handle 5 can also rotate along the flat section 73. Therefore, it becomes possible to change the grip section 80 to a desired location depending on the work without having to increase the dimension in the direction of the axis line 61 of the electric hedge trimmer 1, and thus operability can be greatly improved. In addition, even when it is difficult to grasp the sub handle 5 depending on the work, the motor housing section 2a is provided on the housing 2, so that it is possible for the user to grasp the protruding portion of the motor housing section 2a instead of the sub handle 5. Therefore, the operability is even further improved. The flat motor 6 that is housed in the housing 2 has a motor housing 53 that comprises a first motor housing section 50 and a second motor housing section 51. The motor housing 53 is formed so that it can be separated in a different direction from the separation direction of the housing 2, comprising the half housing sections 22a, 22b. Therefore, assemblability can be further improved.

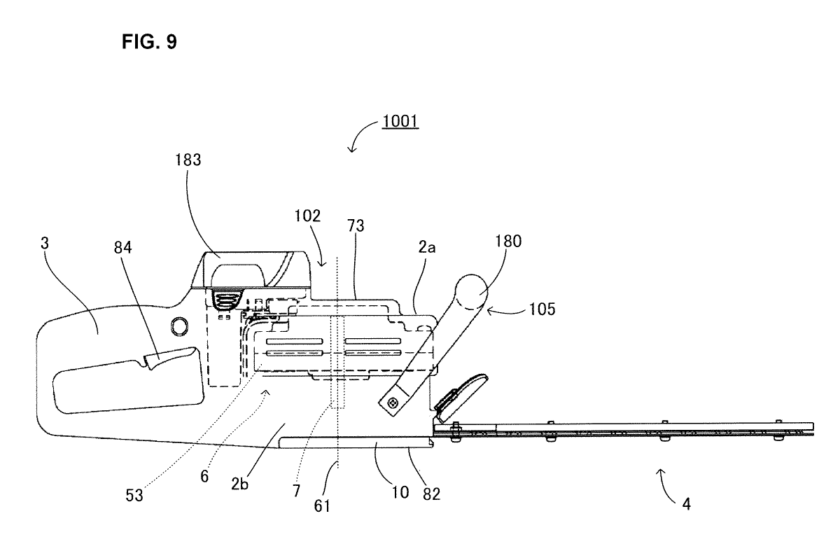

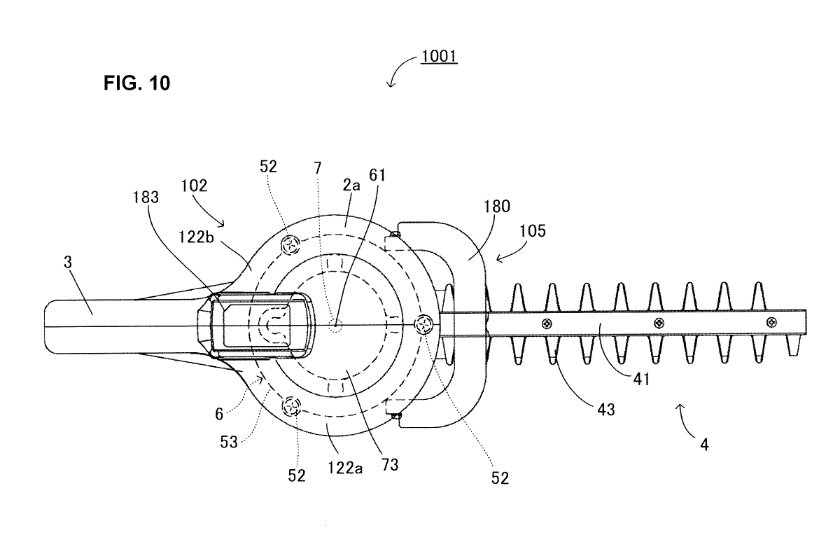

Next, electric hedge trimmer 1001 of a second embodiment of the present invention will be explained with reference to FIG. 9 and FIG. 10. In the electric hedge trimmer 1001 of this embodiment, the installation location of the battery 183 and the installation location of the sub handle 105 have been changed from that of the electric hedge trimmer 1 of the first embodiment. Component elements that are the same as those of the first embodiment are assigned the same reference numbers, and a detailed explanation of those elements is omitted.

As illustrated in FIG. 9 and FIG. 10, a housing 102 comprises half housing sections 122a, 112b, and a battery 183 is installed in that housing 102 between the motor output shaft 7 and main handle 3 as seen in the direction of the axis line 61 of the motor output shaft 7, such that the battery 183 overlaps part of the motor housing 53 and can be removed from the flat section side 73 of the housing 102. Moreover, a substantially C-shaped sub handle 105 is installed on the housing 102 such that it extends in the direction opposite that of the main handle 3 as seen in the direction of the axis line 61 of the motor output shaft 7. In FIG. 9, the sub handle 105 extends diagonally upward from the gear housing section 2b of the housing 102, with a grip section 180 of the sub handle 105 positioned in front of the motor housing section 2a of the housing 2.

With the electric hedge trimmer 1001 that are constructed in this way, in addition to the effect described above obtained by using a flat motor 6, heavy components such as the flat motor 6 and battery 183 are located near the middle section of the electric hedge trimmer 1001, so that the moment of inertia of the electric hedge trimmer 101 becomes small, and operability of rotating the electric hedge trimmer 1001 during work is improved. In addition, the main handle 3 and sub handle 105 are positioned so that the heavy components such as the flat motor 6 and battery 183 are located in between them. Therefore, it is possible to further improve operability of rotating the electric hedge trimmer 101 when the worker performs work by holding both the main handle 3 and sub handle 105.

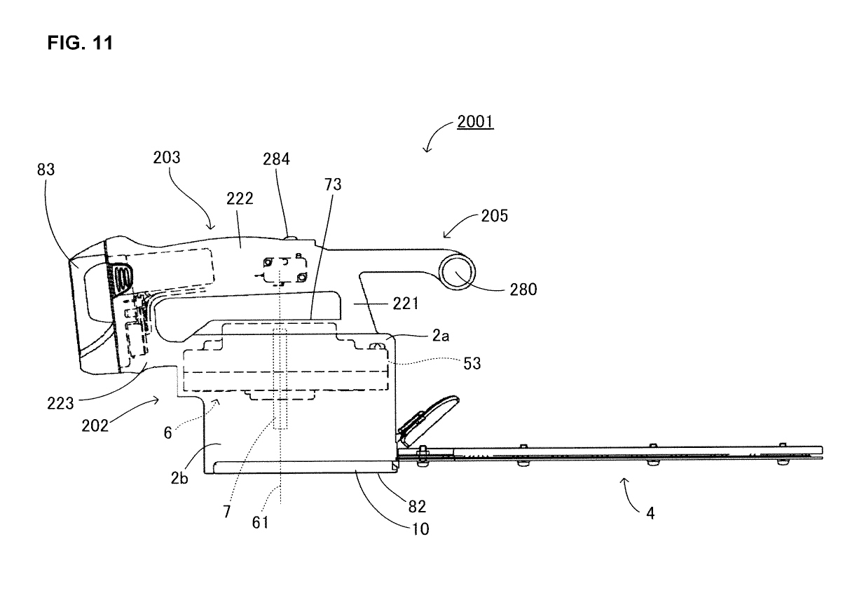

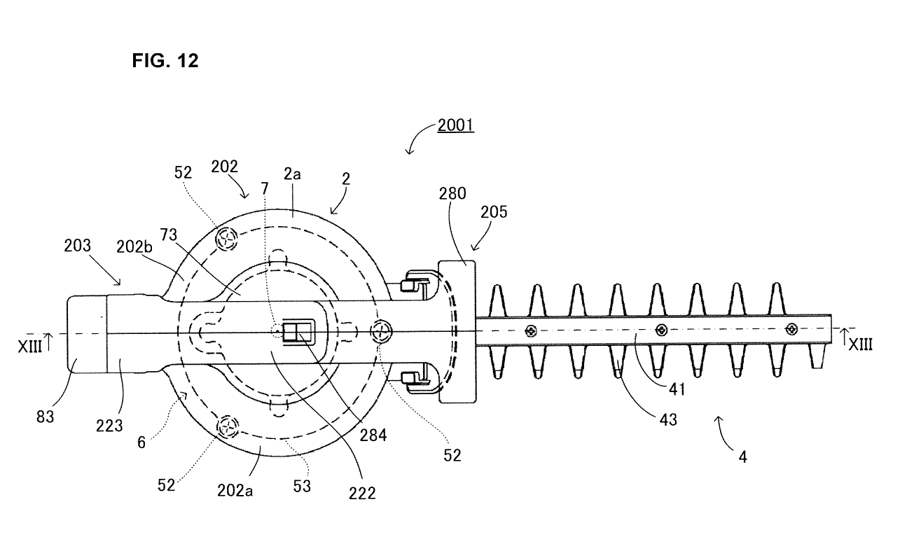

Next, electric hedge trimmer 2001 of a third embodiment of the present invention will be explained with reference to FIG. 11 to FIG. 13. In the electric hedge trimmer 2001 of this embodiment, the locations of the main handle 203 and sub handle 205 have been changed from those of the electric hedge trimmer 1 of the first embodiment. The component elements that are the same as those in the first or second embodiment are assigned the same reference numbers, and a detailed explanation of those elements is omitted.

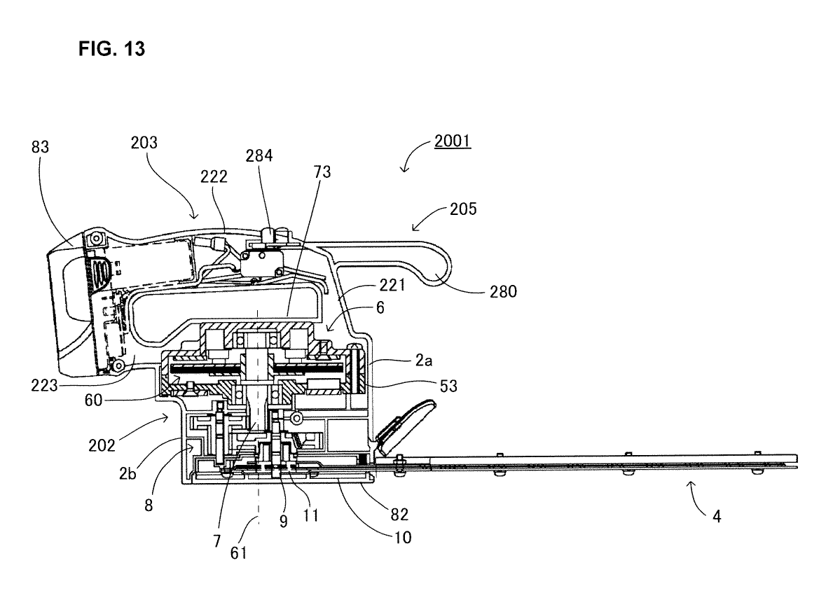

As illustrated in FIG. 11 to FIG. 13, the housing 202 comprises half housing sections 202a, 202b, and the main handle 203 is integrated with and formed above the housing 202 (upward in FIGS. 11 and 13). The main handle 203 has a first protruding section (handle protruding section) 221 that protrudes from the housing 202 in a direction opposite the protruding direction of the motor output shaft 7. A handle grip section 222 is connected to the end section of the first protruding section 221 that is away from the housing. The handle grip section 222 is away from the flat section 73 and extends toward the rear as seen in the direction of the axis line 61 of the motor output shaft 7 substantially parallel to the protruding direction of the blade unit 4 so that it overlaps the motor output shaft 7. A sliding switch 284 that controls the rotation of the flat motor 6 is provided on the handle grip section 222 such that the switch can slide in the extending direction of the handle grip section 222 (protruding direction of the blade unit 4). A second protruding section 223 that is connected to the motor housing section 2a of the housing 202 is connected to the end section on the opposite side of the handle grip section 222 from where the first protruding section 221 is connected. In addition, a battery 83 that supplies electric power to the flat motor 6 is installed in the rear end (end section away from the blade unit 4) of the main handle 203 and second protruding section 223 such that it is removable. Moreover, a sub handle 205 is provided on the main handle 203 such that it protrudes toward the front (protruding direction of the blade unit 4), and this sub handle 205 has a grip section 280 that extends nearly perpendicularly to the direction that that main handle 203 extends in as seen in the direction of the axis line 61 of the motor output shaft 7.

With the electric hedge trimmer 2001 constructed as described above, in addition to the effect described above that is obtained by using a flat motor 6, by locating the main handle 203 on the top side of the housing 202, it is possible to concentrate the heavy components such as the flat motor 6 and gear unit 8 underneath the main handle 203, and the user is able to operate the electric hedge trimmer 2001 in a suspended state, thus operability is improved by reducing the load on the arms of the user during trimming work. Moreover, the amount of protrusion of the main handle 203 toward the side opposite from the blade section 4 can be suppressed, so that it is possible to make the electric hedge trimmer 2001 more compact by suppressing the dimension in protruding direction of the blades (left-right direction in the figures). In addition, by using a sliding switch 284 that slides in the extending direction of the handle grip section 222, it becomes possible to suppress the dimension in the direction of the axis line 61 of the motor output shaft 7 that is required for operation, so that the electric hedge trimmer 2001 can also be made more compact in the direction of the axis line 61 of the motor output shaft 7. Furthermore, a sub handle 205 is provided having a grip section 280 that extends nearly perpendicular to the extending direction of the handle grip section 222 of the main handle. Therefore, the user can operate the electric hedge trimmer 2001 by holding the sub handle 205 in addition to the main handle 203, thus further improving operability. The battery 83 is installed in the rear end section of the main handle 203, so that even though a long blade section 4 is attached, the center of gravity of the electric hedge trimmer 2001 with main handle 203 can be brought close to the body, thus making it possible to improve operability.

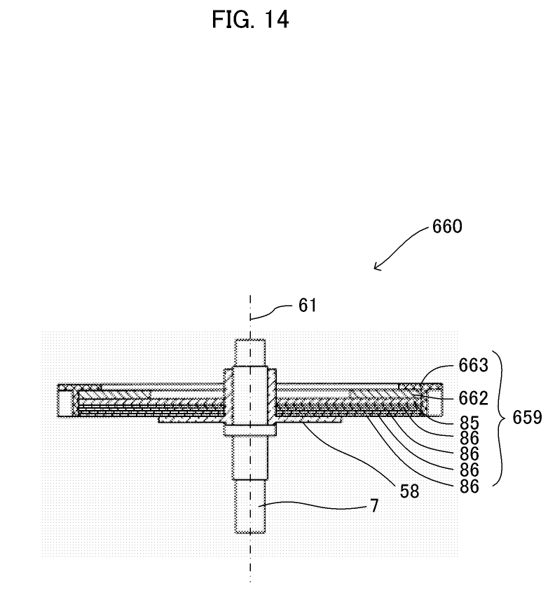

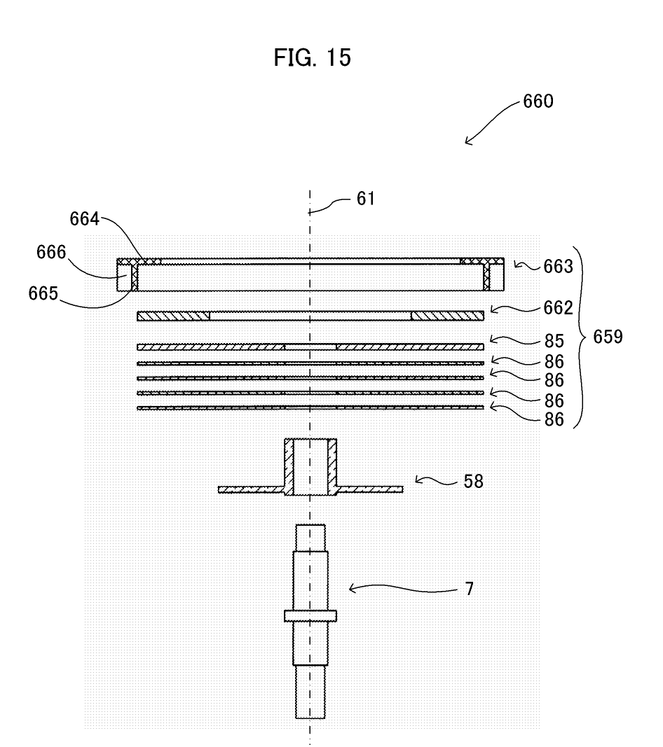

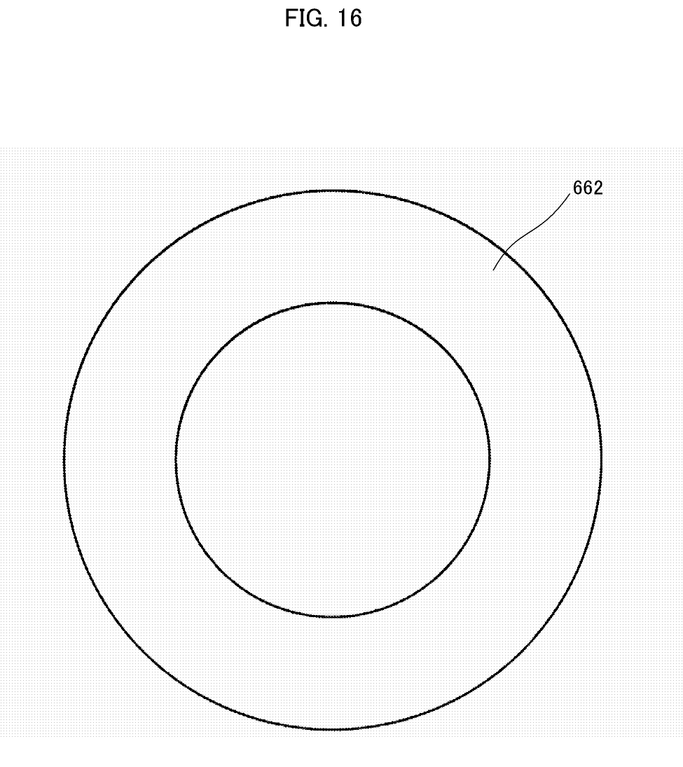

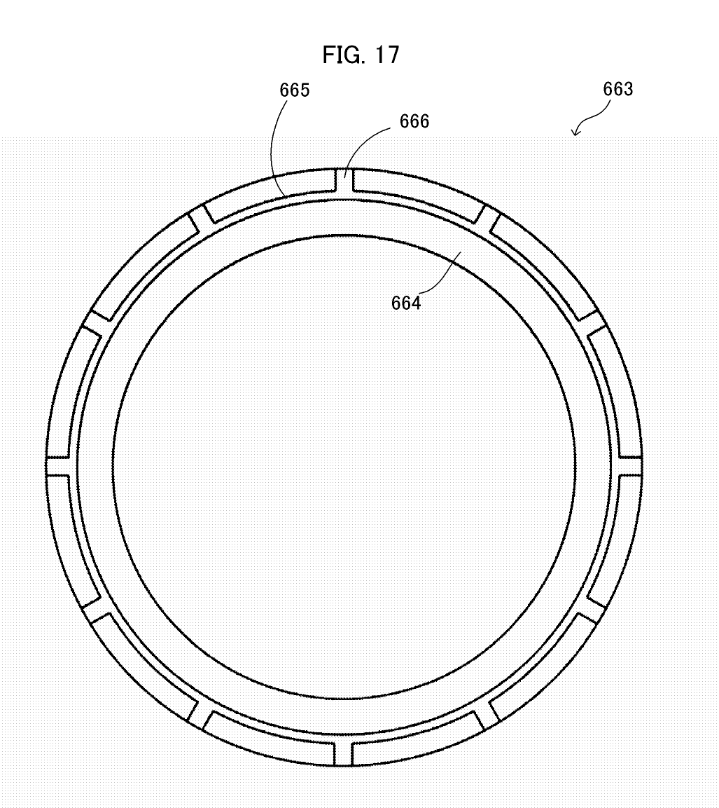

It is also possible to use the rotor 660 illustrated in FIG. 14 and FIG. 15 as a variation of the rotor 60 used in the first through third embodiments described above. As illustrated in FIG. 14, this rotor 660 further comprises a yoke section 662 and a fan section 663 that are aligned with and fastened to the top of the coil/commutator disk 85 of the coil disk 59 of the rotor 60 that is used in the first through third embodiments, and have the axis line 61 as a center so that they are concentric with the coil/commutator disk 85 and coil disk unit 86. As illustrated in FIG. 14 to FIG. 16, the yoke section 662 is substantially ring shaped, and has an outer diameter that is nearly the same as that of the coil/commutator disk 85 and coil disk unit 86. The yoke section 662 also overlaps the coil area (not illustrated in the figure) of the coil/commutator disk 85, and has an inner diameter that will not overlap the commutator area (not illustrated in the figure) on the inside of the coil/commutator disk 85. When the rotor 60 is assembled in the flat motor (not illustrated in the figure), the yoke section 662 faces the permanent magnet 63 with the coil/commutator disk 85 and coil disk unit 86 in between. Moreover, as illustrated in FIG. 14, FIG. 15 and FIG. 17, the fan unit 663 has an outer diameter that is greater then that of the yoke section 662. The fan section 663 comprises a ring shaped ring section 664 having an inner diameter that overlaps part of the yoke section 662 from the outer edge of the yoke section 662 toward the inside, a cylindrical shaped retainer 665 that protrudes from the ring section 664 toward the side of the yoke section 662 (downward in the figure), and a plurality of fan blade sections 666 that extend from the retainer 665 toward the outside in the radial direction.

With the rotor 660 constructed as described above, the yoke section 662 and fan section 663 are provided on the outside in the radial direction of the coil disk 659. Therefore, the moment of inertia of the rotor 660 around the motor output shaft 7 increases. Consequently, it is possible to absorb fluctuation in torque when the direction of motion is converted by the cam 11, or due to resistance when upper blade 43 and lower blade 44 are moving back and forth or cutting, and thus it is possible to stabilize the rotation of the motor. In addition, a plurality of fan blade sections 666 is provided on the end section in the radial direction of the coil disk 659. Therefore, as the rotor 660 rotates, airflow occurs inside the housing 53, making it possible to efficiently cool the flat motor 6.

In the case of any of the embodiments described above, a flat motor 6 is used having construction such that the coil disk 59, 659 rotates as part of the rotor, and permanent magnets 63 are fastened to the motor housing 53 as the stator. However, the electric hedge trimmer 1, 1001, 2001 of the present invention are not limited to this. For example, a flat brushless motor can be used having construction wherein the permanent magnet integrally rotates with the output shaft 7 to form the rotor, and the coil disk is fastened to the motor housing to form the stator. Furthermore, the coil disk does not necessarily need to comprise a coil disk that is constructed using a printed circuit board, and as long as it can be formed into a flat compact shape, the motor can comprise a coil disk having a plurality of coils arranged in a disk shape. Moreover, in any of the embodiments described above the flat motor 6 is driven by a battery 83, 183. However, the electric hedge trimmer of the present invention are not limited to this, and instead of a battery, the power supply to the flat motor 6 can comprise a power-supply cord that connects to an external power supply. In addition, in the embodiments, so-called hedge trimmer type electric hedge trimmer were explained wherein the blades can move in a vertical direction to cut plants, however, the hedge trimmer could be of the cutting type that can cut grass by the blades being able to move in the horizontal direction.

Having described and illustrated the principles of this application by reference to preferred embodiments, it should be apparent that the preferred embodiments may be modified in arrangement and detail without departing from the principles disclosed herein, and that it is intended that the application be construed as including all such modification and variations insofar as they come within the spirit and scope of the subject matter disclosed herein.

What is claimed is:

1. An electric hedge trimmer, comprising:
a housing;
a flat motor having a magnetic flux generating unit that is provided inside the housing, a rotor that includes a motor output shaft and that is rotatably provided inside the housing, and a stator that is fastened inside the housing; wherein one of either the rotor or the stator has a disk shaped coil disk around which a plurality of ring-shaped coils are arranged in the circumferential direction with the motor output shaft as the center as seen in the direction of the motor output shaft; and the other one of either the rotor or the stator generates a magnetic flux that passes through the coil disk in the axial direction of the motor output shaft;
a motion conversion device that is capable of connecting to blades that protrude from the housing and move in a reciprocating motion, the motion conversion device converting the rotating motion of the motor output shaft to reciprocating motion.

2. The electric hedge trimmer according to claim 1, wherein
the rotor and stator are housed in a motor housing;
the motor output shaft protrudes from the motor housing; and
the motor housing is housed in the housing.

3. The electric hedge trimmer according to claim 1, wherein
the housing is separable, having a plane of separation that is substantially parallel with the protruding direction of the blades from the housing;
the motor housing is separable, having a plane of separation that is substantially perpendicular to the axial direction of the motor output shaft; and
the separation plane of the housing and the separation plane of the motor housing are substantially orthogonal.

4. The electric hedge trimmer according to claim 1, further comprising:
a reducer that is provided between the flat motor and motion conversion device on the inside of the housing; the reducer being connected to the motor output shaft and having a reducer output shaft that outputs the reduced speed of the motor output shaft; wherein
the motion conversion device is connected to the reducer output shaft and converts the rotating motion of the reducer output shaft to reciprocating motion.

5. The electric hedge trimmer according to claim 2, wherein
the rotor includes the coil disk;
the motor housing supports the motor output shaft such that the motor output shaft can rotate; and
the magnetic flux generating unit comprises a magnet and is attached to the motor housing so that the magnet faces the disk surface of the coil disk.

6. The electric hedge trimmer according to claim 1, wherein
the housing comprises:
a flat section that is formed substantially parallel with the disk surface of the coil disk on the opposite side from the blades with the flat motor in between in the axial direction of the motor output shaft;
a bottom section that covers a connecting section which connects the blades and the motion conversion device on the side of the motion conversion device in the direction of the motor output shaft that faces the blades; and
a first handle that is located between the flat section and bottom section of the housing in the axial direction of the motor output shaft, and extends in the direction opposite from protruding direction of the blades with the flat motor in between the handle and the blades.

7. The electric hedge trimmer according to claim 6, wherein
the housing further comprises a protruding section that protrudes from the flat section toward the outside of the housing in the axial direction of the motor output shaft and has a substantially circular outer wall as seen in the axial direction of the motor output shaft; and
a second handle that is installed on the outer wall and comprising an extending section that extends from the protruding section along the flat section, and a grip section that the user holds that is connected to the extending section; the second handle being able to rotate around the protruding section as seen in the axial direction of the motor output shaft.

8. The electric hedge trimmer according to claim 6, further comprising a battery that supplies electric power to the flat motor, wherein the battery is installed at the end section of the first handle that is away from the blade as seen in the axial direction of the motor output shaft such that the battery is removable.

9. The electric hedge trimmer according to claim 6, wherein
the battery that supplies electric power to the flat motor is installed on the housing between the motor output shaft and the first handle as seen in the axial direction of the motor output shaft such that the battery overlaps part of the motor housing and is removable from the flat surface side of the housing.

10. The electric hedge trimmer according to claim 9, wherein
a second handle is installed on the housing such that the second handle extends in the opposite direction from the first handle with the motor output shaft in between the first handle and second handle as seen in the direction of the motor output shaft.

11. The electric hedge trimmer according to claim 1, wherein the housing comprises:
a flat section that is formed substantially parallel with the disk surface of the coil disk on the opposite side of the blades in the axial direction of the motor output shaft with the flat motor in between; and
a first handle having a handle protruding section that protrudes from the housing in the direction of the motor output shaft opposite the direction facing the blades, a handle grip section that is apart from the flat section and extends substantially parallel to the protruding direction of the blades from the end section of the handle protruding section that is away from the housing such that the handle grip section overlaps the motor output shaft as seen in the direction of the motor output shaft.

12. The electric hedge trimmer according to claim 11, wherein a sliding switch is provided in the handle grip section such that the switch can slide along the extending direction of the handle grip section and control the rotation of the flat motor.

13. The electric hedge trimmer according to claim 11, wherein
a second handle is provided on the first handle such that the second handle protrudes from the end section of the blade side of the first handle toward substantially the same direction as the protruding direction of the blades as seen in the direction of the motor output shaft, the second handle having a grip section that extends substantially perpendicular to the extending direction of the first handle.

14. The electric hedge trimmer according to claim 11, wherein a battery that supplies electric power to the flat motor is installed in the end section of the first handle that is away from the blades as seen in the axial direction of the motor output shaft such that the battery is removable.

15. An electric hedge trimmer, comprising:
a housing;
a flat motor having a disk shaped coil disk;
a motion conversion device is capable of connecting to blades that protrude from the housing and move in a reciprocating motion, the motion conversion device converting the rotating motion of the flat motor to reciprocating motion.
